(19) United States
(12) Patent Application Publication
(10) Pub. No.: US 2025/0286325 A1
(43) Pub. Date: Sep. 11, 2025

(54) MODULAR CONNECTOR AND CONNECTOR ASSEMBLY WITH GROUNDING CONNECTION MEMBER

(71) Applicant: DONGGUAN LUXSHARE TECHNOLOGIES CO., LTD, Dongguan City (CN)

(72) Inventors: Xiaoping WU, Dongguan City (CN); Chenhui ZENG, Dongguan City (CN); Tao SONG, Dongguan City (CN)

(73) Assignee: DONGGUAN LUXSHARE TECHNOLOGIES CO., LTD, Dongguan City (CN)

(21) Appl. No.: 18/758,881

(22) Filed: Jun. 28, 2024

(30) Foreign Application Priority Data
Mar. 10, 2024 (CN) 202410269111.6

(51) Int. Cl. H01R 13/6587; H01R 12/72; H01R 13/514

(52) U.S. Cl. CPC H01R 13/6587; H01R 12/724; H01R 13/514

(57) ABSTRACT

A modular connector includes a first housing, a first terminal module, a second terminal module and a grounding connection member. The first terminal module includes a number of first conductive terminals and a first metal shielding plate. The first conductive terminals include a first ground terminal, a first signal terminal, a second signal terminal and a second ground terminal. The second terminal module includes a number of second conductive terminals and a second metal shielding plate. The second conductive terminals include a third ground terminal, a third signal terminal, a fourth signal terminal and a fourth ground terminal. The grounding connection member is electrically connected to the first ground terminal, the second ground terminal and the second metal shielding plate, respectively, so as to improve the quality of signal transmission. A connector assembly including the modular connector is also disclosed.

### CROSS-REFERENCE TO RELATED APPLICATION

This patent application claims priority of a Chinese Patent Application No. 202410269111.6, filed on Mar. 10, 2024 and titled “MODULAR CONNECTOR AND CONNECTOR ASSEMBLY”, the entire content of which is incorporated herein by reference.

### TECHNICAL FIELD

The present disclosure relates to a modular connector and a connector assembly, which belong to the technical field of connectors.

### BACKGROUND

A connector assembly in the related art generally includes a modular connector (such as a female connector) and a mating connector (such as a male connector) that mates with the modular connector. The modular connector usually includes a plurality of first terminal modules and a plurality of second terminal modules. The first terminal modules and the second terminal modules are arranged alternately. The first terminal module usually includes a first fixing block, a plurality of first conductive terminals fixed to the first fixing block, and a first metal shielding plate matched with the first fixing block. The plurality of first conductive terminals usually include a plurality of first signal terminals and a plurality of first ground terminals.

Similarly, the second terminal module usually includes a second fixing block, a plurality of second conductive terminals fixed to the second fixing block, and a second metal shielding plate matched with the second fixing block. The plurality of second conductive terminals usually include a plurality of second signal terminals and a plurality of second ground terminals.

On a terminal module, such as the first terminal module, the first metal shielding plate can be designed with ribs to be in contact with corresponding first ground terminals, thereby achieving a better ground shielding effect.

However, as the connector assembly continues to improve signal transmission quality, there is still room for improvement on the ground shielding design in the related art.

### SUMMARY

An object of the present disclosure is to provide a module connector and a connector assembly with improved ground shielding effect.

In order to achieve the above object, the present disclosure adopts the following technical solution: a modular connector, including: a first housing including a first base; the first base including a first mating surface, a plurality of first mating holes extending through the first mating surface, and a plurality of second mating holes extending through the first mating surface; a first terminal module being at least partially assembled to the first housing; the first terminal module including a first fixing block, a plurality of first conductive terminals fixed to the first fixing block, and a first metal shielding plate located on at least one side of the first fixing block; each first conductive terminal including a first contact portion protruding beyond the first fixing block along a first direction; the first contact portion being disposed corresponding to a corresponding first mating hole; the plurality of first conductive terminals including at least a first ground terminal, a first signal terminal, a second signal terminal and a second ground terminal; the first signal terminal and the second signal terminal being located between the first ground terminal and the second ground terminal; the first metal shielding plate including a first extension portion protruding beyond the first fixing block along the first direction; the first extension portion including a first grounding elastic arm protruding toward a side where the first contact portions are located; a second terminal module being at least partially assembled to the first housing; the second terminal module including a second fixing block, a plurality of second conductive terminals fixed to the second fixing block, and a second metal shielding plate located on at least one side of the second fixing block; each second conductive terminal including a second contact portion protruding beyond the second fixing block along the first direction; the second contact portion being disposed corresponding to a corresponding second mating hole; the plurality of second conductive terminals including at least a third ground terminal, a third signal terminal, a fourth signal terminal and a fourth ground terminal; the third signal terminal and the fourth signal terminal being located between the third ground terminal and the fourth ground terminal; the second metal shielding plate including a second extension portion protruding beyond the second fixing block along the first direction; the second extension portion including a second grounding elastic arm protruding toward a side where the second contact portions are located; and a grounding connection member being at least partially located between the first terminal module and the second terminal module; the grounding connection member being electrically connected to the first ground terminal, the second ground terminal and the second metal shielding plate, respectively.

In order to achieve the above object, the present disclosure adopts the following technical solution: a modular connector, including: a first housing; a plurality of first terminal modules being at least partially assembled to the first housing; each first terminal module including a first fixing block, a plurality of first conductive terminals fixed to the first fixing block, and a first metal shielding plate located on at least one side of the first fixing block; each first conductive terminal including a first contact portion protruding beyond the first fixing block along a first direction; the plurality of first conductive terminals at least including ground terminals and signal terminals; the first metal shielding plate including a first extension portion protruding beyond the first fixing block along the first direction; the first extension portion including a first grounding elastic arm protruding toward a side where the first contact portions are located; a plurality of second terminal modules being at least partially assembled to the first housing; each second terminal module including a second fixing block, a plurality of second conductive terminals fixed to the second fixing block, and a second metal shielding plate located on at least one side of the second fixing block; each second conductive terminal including a second contact portion protruding beyond the second fixing block along the first direction; the plurality of second conductive terminals at least including ground terminals and signal terminals; the second metal shielding plate including a second extension portion protruding beyond the second fixing block along the first direction; the second extension portion including a second grounding elastic arm protruding toward a side where the second contact portions are located; a plurality of grounding connection members; the plurality of first terminal modules and the plurality of second terminal modules being alternately arranged along a second direction; each grounding connection member being at least partially located between one first terminal module and one second terminal module; some of the grounding connection members are electrically connected to the ground terminals of the first terminal modules and the second metal shielding plates of the second terminal modules, respectively; another some of the grounding connection members are electrically connected to the ground terminals of the second terminal modules and the first metal shielding plates of the first terminal modules, respectively.

In order to achieve the above object, the present disclosure adopts the following technical solution: a connector assembly, including: a module connector; and a mating connector including a second housing and a plurality of mating conductive terminals fixed to the second housing; the second housing defining a receiving space configured to at least partially receive the modular connector; each mating conductive terminal including an insertion portion protruding into the receiving space; the modular connector including: a first housing including a first base; the first base including a first mating surface, a plurality of first mating holes extending through the first mating surface, and a plurality of second mating holes extending through the first mating surface; a first terminal module being at least partially assembled to the first housing; the first terminal module including a first fixing block, a plurality of first conductive terminals fixed to the first fixing block, and a first metal shielding plate located on at least one side of the first fixing block; each first conductive terminal including a first contact portion protruding beyond the first fixing block along a first direction; the first contact portion being disposed corresponding to a corresponding first mating hole; the plurality of first conductive terminals including at least a first ground terminal, a first signal terminal, a second signal terminal and a second ground terminal; the first signal terminal and the second signal terminal being located between the first ground terminal and the second ground terminal; the first metal shielding plate including a first extension portion protruding beyond the first fixing block along the first direction; the first extension portion including a first grounding elastic arm protruding toward a side where the first contact portions are located; a second terminal module being at least partially assembled to the first housing; the second terminal module including a second fixing block, a plurality of second conductive terminals fixed to the second fixing block, and a second metal shielding plate located on at least one side of the second fixing block; each second conductive terminal including a second contact portion protruding beyond the second fixing block along the first direction; the second contact portion being disposed corresponding to a corresponding second mating hole; the plurality of second conductive terminals including at least a third ground terminal, a third signal terminal, a fourth signal terminal and a fourth ground terminal; the third signal terminal and the fourth signal terminal being located between the third ground terminal and the fourth ground terminal; the second metal shielding plate including a second extension portion protruding beyond the second fixing block along the first direction; the second extension portion including a second grounding elastic arm protruding toward a side where the second contact portions are located; and a grounding connection member being at least partially located between the first terminal module and the second terminal module; the grounding connection member being electrically connected to the first ground terminal, the second ground terminal and the second metal shielding plate, respectively; wherein the insertion portions are configured to be in contact with a corresponding first contact portion of the first conductive terminal, a corresponding first grounding elastic arm, a corresponding second contact portion of the second conductive terminal and a corresponding second grounding elastic arm.

Compared with the prior art, the modular connector of the present disclosure includes a grounding connection member. The grounding connection member is at least partially located between the first terminal module and the second terminal module. The grounding connection member is electrically connected to the first ground terminal, the second ground terminal and the second metal shielding plate, respectively. With this arrangement, the ground shielding structures of the first terminal module and the second terminal module are connected in series, thereby improving the quality of signal transmission.

### BRIEF DESCRIPTION OF DRAWINGS

FIG. 1 is a schematic perspective view of a connector assembly in accordance with an embodiment of the present disclosure, in which a mating connector and a module connector are mated with each other;

FIG. 2 is a perspective view of FIG. 1 from another angle;

FIG. 3 is a partially exploded perspective view of FIG. 1;

FIG. 4 is a partially exploded perspective view of FIG. 3 from another angle;

FIG. 5 is a partially exploded perspective view of the mating connector shown in FIG. 3;

FIG. 6 is a partially exploded perspective view of FIG. 5 from another angle;

FIG. 7 is a partially exploded perspective view of the modular connector in FIG. 3;

FIG. 8 is a partially exploded perspective view of FIG. 7 from another angle;

FIG. 9 is a partially exploded perspective view of FIG. 7 with a first housing removed;

FIG. 10 is a partially exploded perspective view of FIG. 9 from another angle;

FIG. 11 is a partially exploded perspective view of FIG. 7 after removing the first housing, in which a second terminal module is separated;

FIG. 12 is a further partial perspective exploded view of FIG. 11, in which a grounding connection member is further separated;

FIG. 13 is a partially exploded perspective view of FIG. 12 from another angle;

FIG. 14 is a top view of a plurality of first terminal modules and a plurality of second terminal modules in FIG. 9 when they are assembled together;

FIG. 15 is a schematic perspective view of one first terminal module, one grounding connection member and one second terminal module which are separated from one another;

FIG. 16 is an exploded perspective view of the second terminal module in FIG. 15;

FIG. 17 is an exploded perspective view of the first terminal module in FIG. 15;

FIG. 18 is an exploded perspective view of FIG. 16 from another angle;

FIG. 19 is an exploded perspective view of FIG. 17 from another angle;

FIG. 20 is a schematic perspective view of part of the first terminal modules, part of the second terminal modules and a retaining sheet when assembled together;

FIG. 21 is a perspective schematic view of the first terminal modules and the second terminal modules of the modular connector when mated with mating conductive terminals of the mating connector;

FIG. 22 is a top view of FIG. 21;

FIG. 23 is a partial enlarged view of a frame portion B in FIG. 22;

FIG. 24 is a perspective view of FIG. 21 from another angle;

FIG. 25 is a schematic perspective view of a mutual positional relationship between the plurality of first terminal modules, the plurality of second terminal modules and the plurality of grounding connection members in FIG. 9 when they are assembled together;

FIG. 26 is a front view of FIG. 25; and

FIG. 27 is a right side view of FIG. 24.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

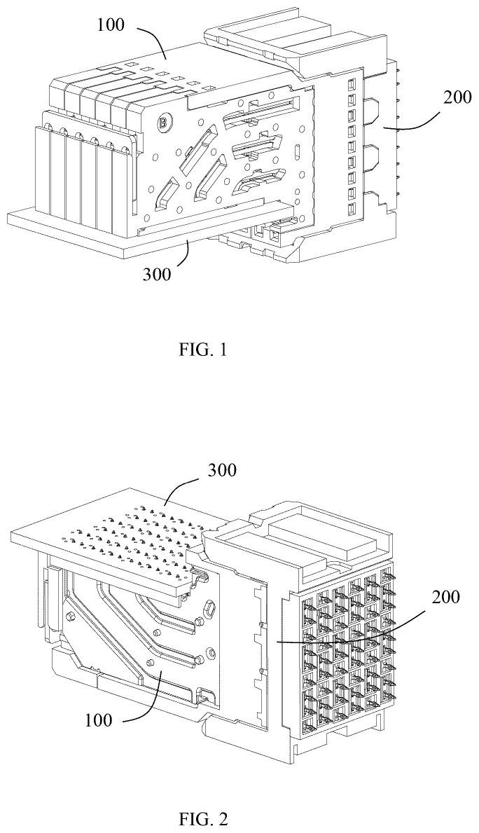

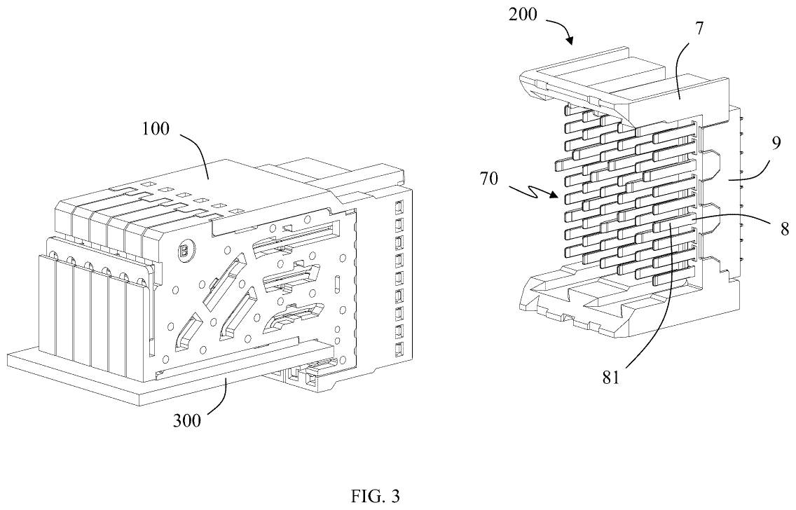

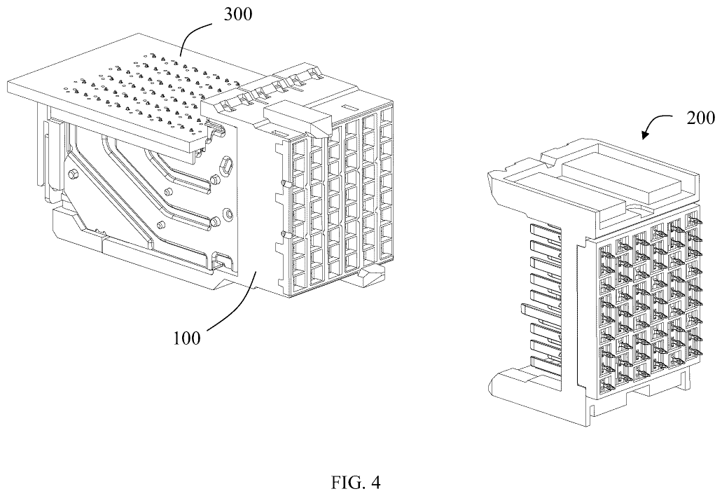

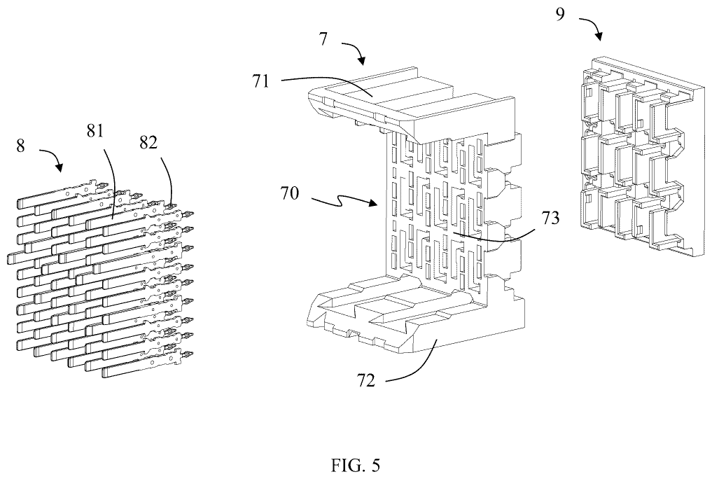

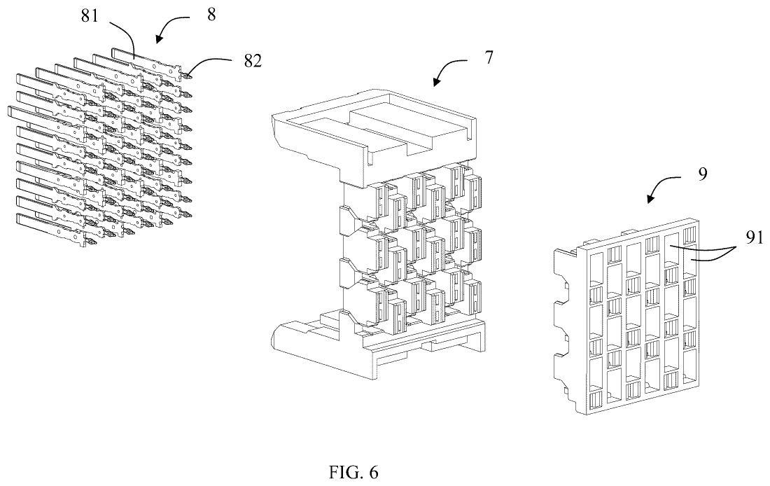

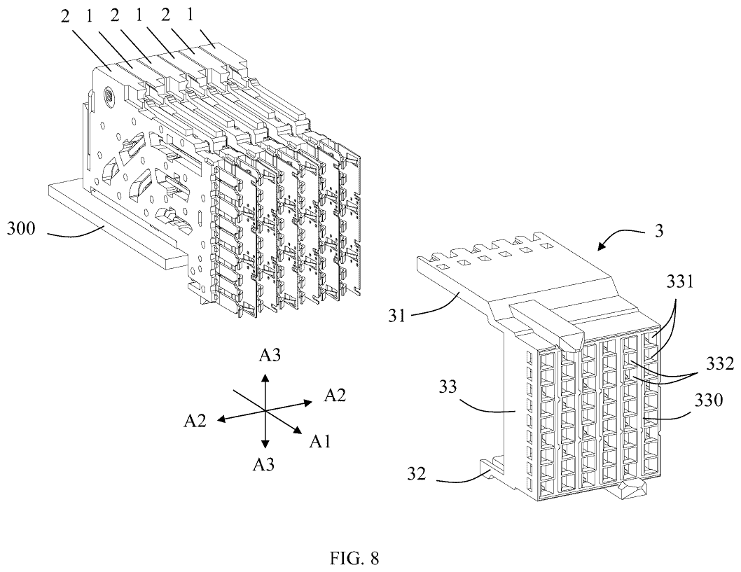

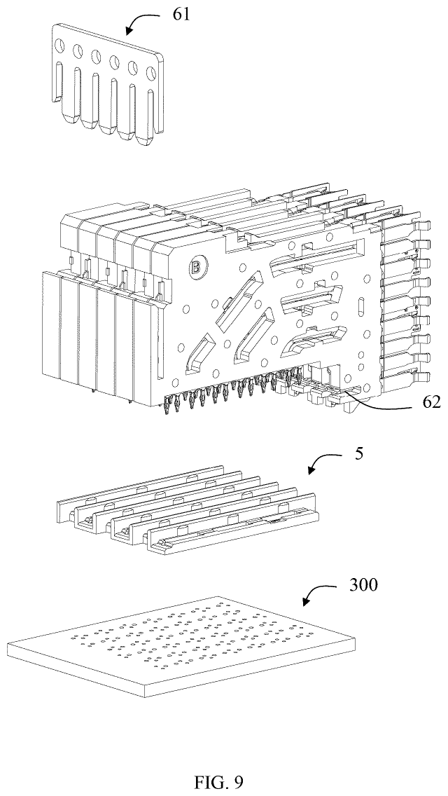

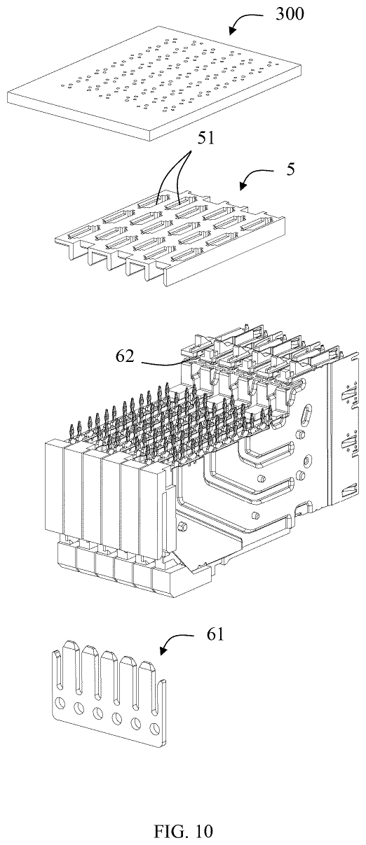

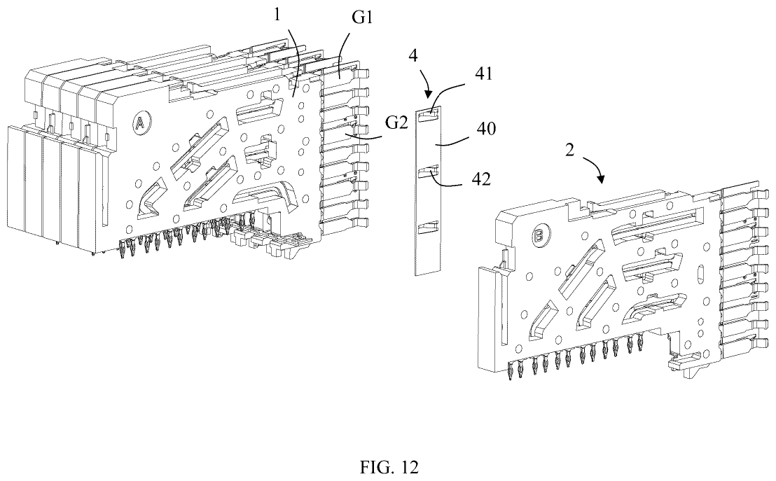

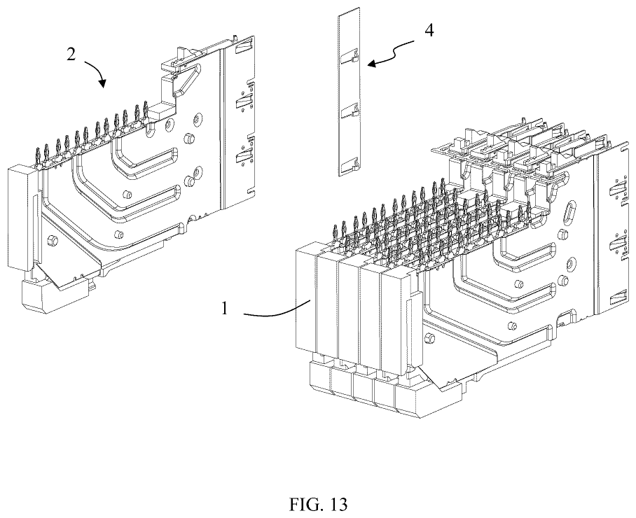

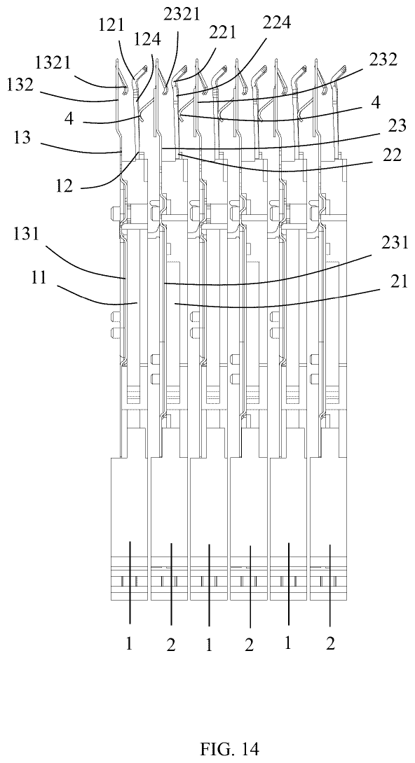

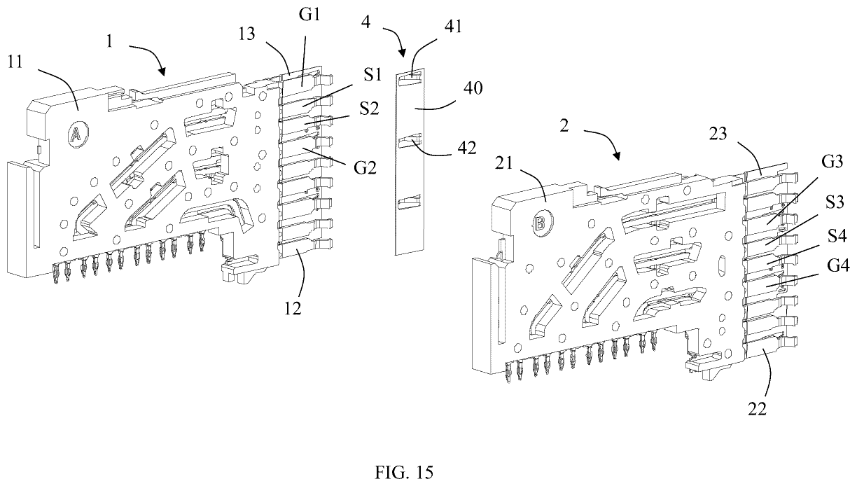

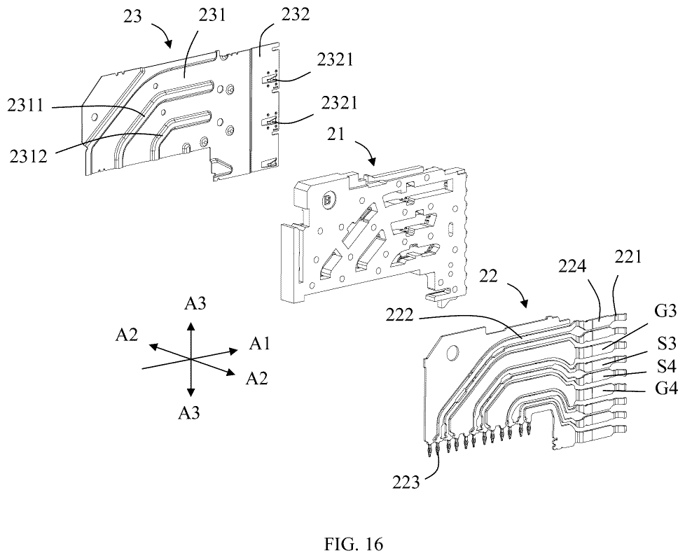

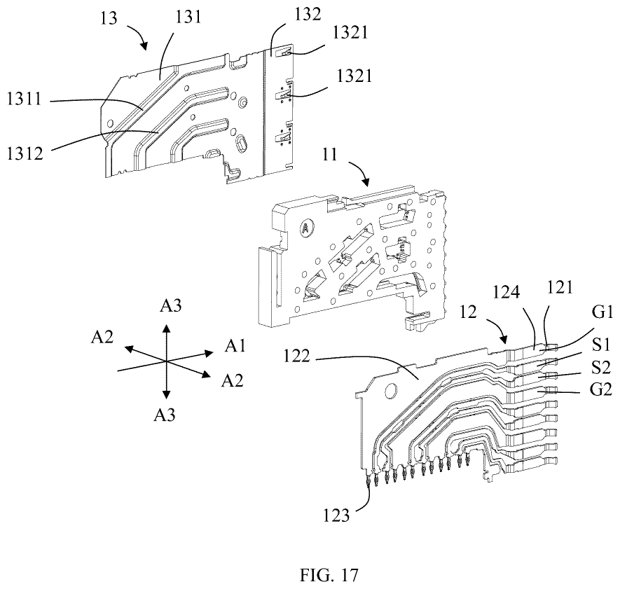

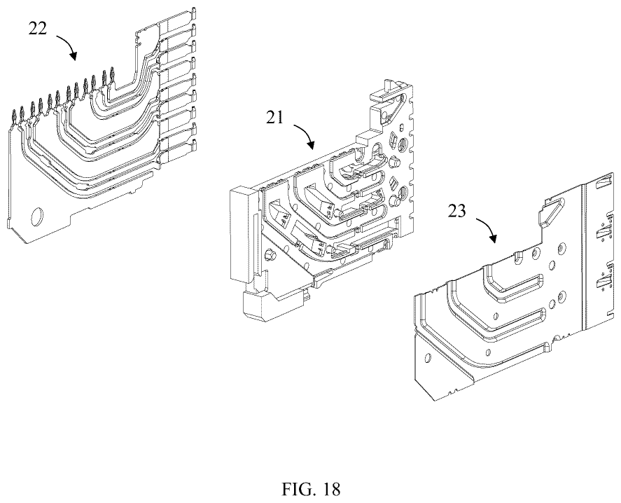

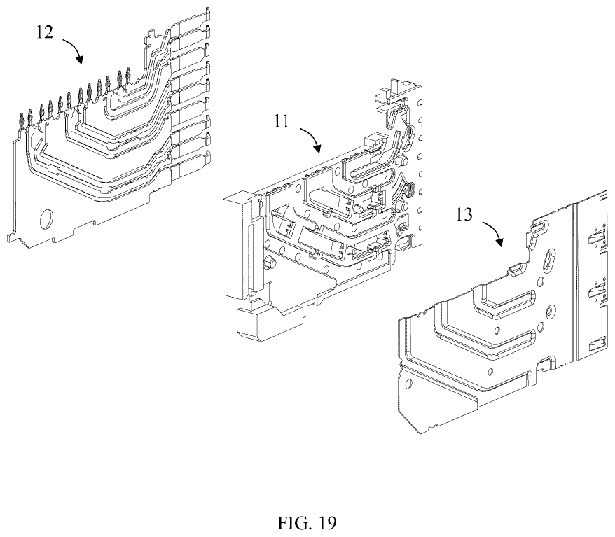

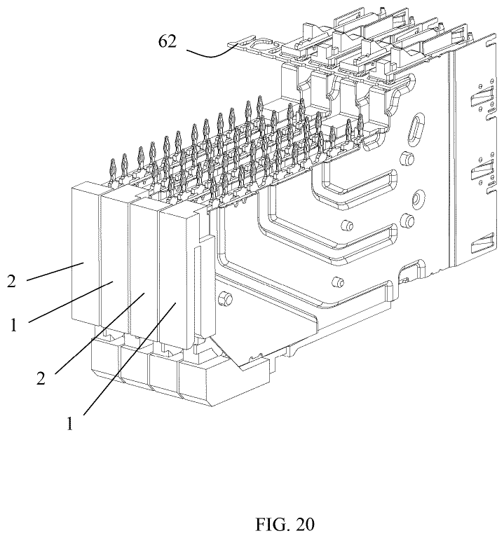

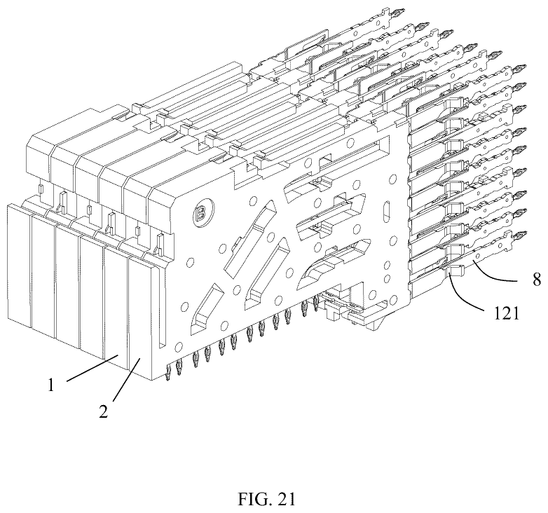

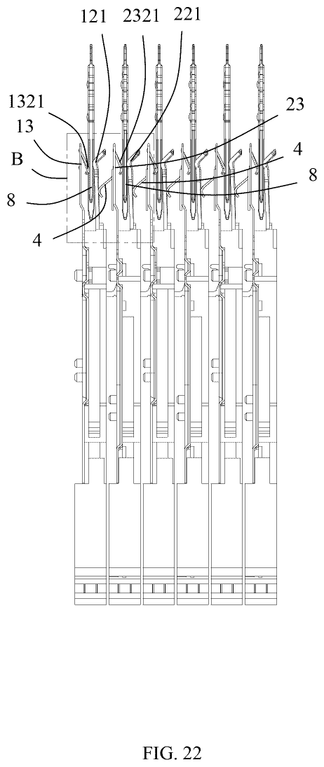

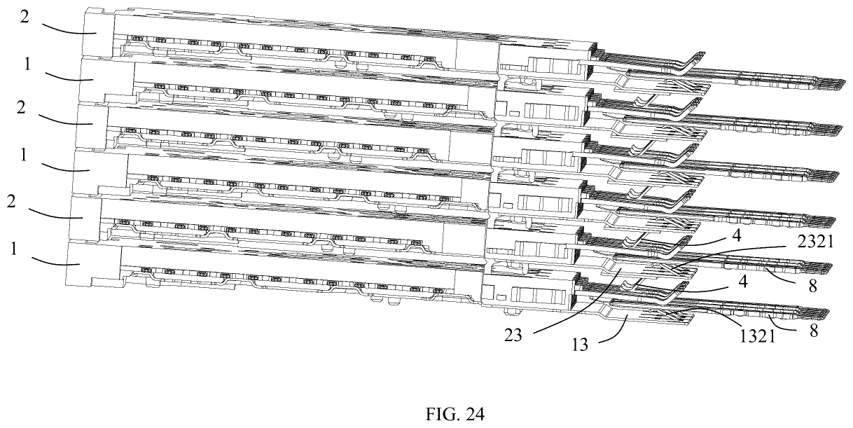

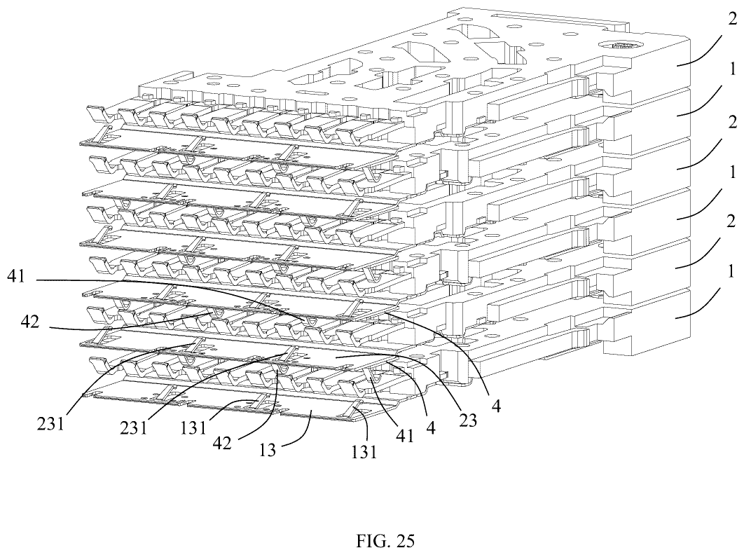

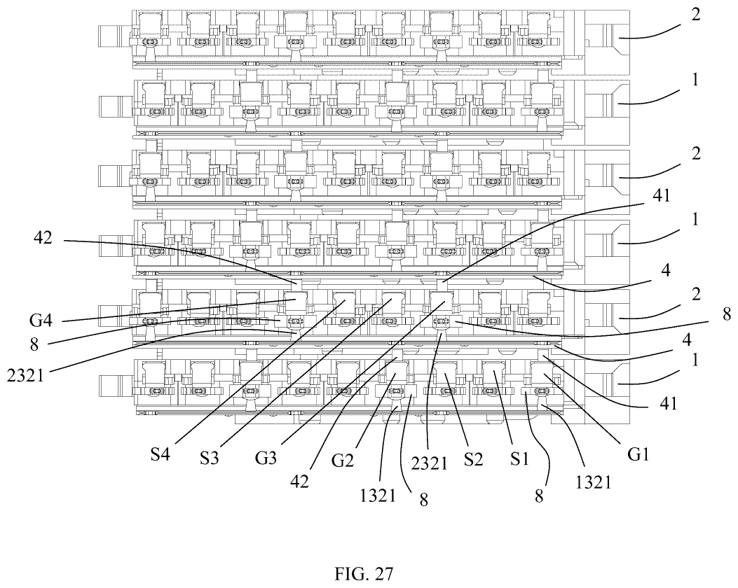

Referring to FIG. 1 to FIG. 27, the present disclosure discloses a connector assembly, which includes a modular connector 100 and a mating connector 200 configured to be mated with the modular connector 100. In the illustrated embodiment of the present disclosure, the module connector 100 is a female backplane connector. The female backplane connector is configured to be mounted on a circuit board 300. The mating connector 200 is a male backplane connector.

Referring to FIG. 1 to FIG. 6, in the illustrated embodiment of the present disclosure, the mating connector 200 includes a second housing 7, a plurality of mating conductive terminals 8 fixed to the second housing 7, and a mounting block 9 mounted to the second housing 7.

In the illustrated embodiment of the present disclosure, the second housing 7 is generally U-shaped and includes a base body portion 73, a first side wall portion 71 integrally extending from one side of the base body portion 73, a second side wall portion 72 integrally extending from the other side of the base body portion 73, and a receiving space 70 formed by the base body portion 73, the first side wall portion 71 and the second side wall portion 72. The receiving space 70 is configured to at least partially receive the modular connector 100.

In the illustrated embodiment of the present disclosure, each mating conductive terminal 8 is substantially straight, and includes an insertion portion 81 protruding into the receiving space 70 and a tail portion 82 protruding beyond the base body portion 73. The plurality of mating conductive terminals 8 include a plurality of signal terminals and a plurality of ground terminals, so as to be in contact with corresponding conductive terminals or grounding elastic arms of the module connector 100.

The mounting block 9 defines a plurality of through holes 91 for allowing the tail portions 82 of the mating conductive terminals 8 to pass through, thereby limiting the tail portions 82 to some extent.

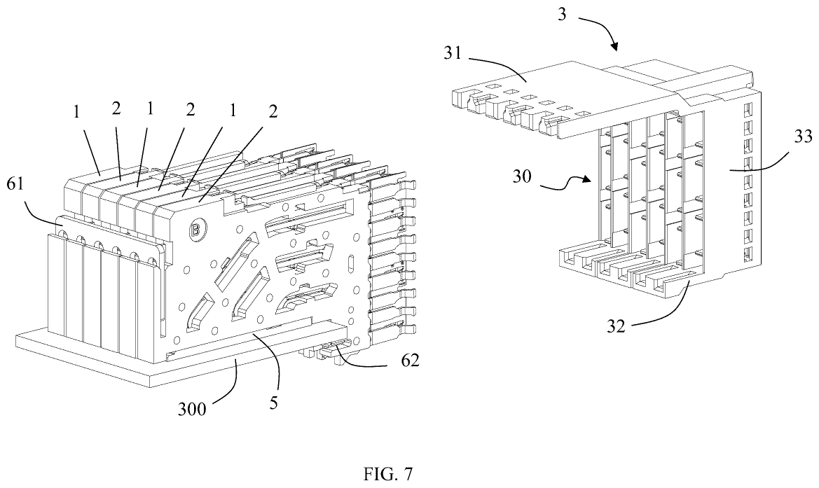

Referring to FIG. 7 to FIG. 15, in the illustrated embodiment of the present disclosure, the modular connector 100 includes a first housing 3, a plurality of first terminal modules 1, a plurality of second terminal modules 2, a plurality of grounding connection members 4, a positioning block 5, an insertion sheet 61 and a retaining sheet 62.

In the illustrated embodiment of the present disclosure, the first housing 3 includes a first base 33, a first side wall 31 integrally extending from one side of the first base 33, a second side wall 32 integrally extending from the other side of the first base 33, and an installation space 30 jointly formed by the first base 33, the first side wall 31 and the second side wall 32. The first base 33 includes a first mating surface 330, a plurality of first mating holes 331 extending through the first mating surface 330, and a plurality of second mating holes 332 extending through the first mating surface 330.

In the illustrated embodiment of the present disclosure, the plurality of first terminal modules 1 and the plurality of second terminal modules 2 are alternately arranged along a second direction A2-A2 (for example, left-right direction). The plurality of first terminal modules 1 and the plurality of second terminal modules 2 are assembled to the first housing 3.

In the illustrated embodiment of the present disclosure, each first terminal module 1 includes a first fixing block 11, a plurality of first conductive terminals 12 fixed to the first fixing block 11 and a first metal shielding plate 13 located on at least one side of the first fixing block 11. In one embodiment of the present disclosure, the plurality of first conductive terminals 12 are insert-molded with the first fixing block 11.

Each first conductive terminal 12 includes a first contact portion 121 protruding beyond the first fixing block 11 along a first direction A1 (for example, a front-to-back direction), a first fixing portion 122 fixed in the first fixing block 11, and a first mounting portion 123 protruding downwardly beyond the first fixing block 11 along a third direction A3-A3 (for example, a top-bottom direction). Any two of the first direction A1, the second direction A2-A2 and the third direction A3-A3 are perpendicular to each other. The first mounting portion 123 is configured to be mounted to the circuit board 300 so as to achieve electrical connection with the circuit board 300. In the illustrated embodiment of the present disclosure, each first conductive terminal 12 includes a first elastic arm 124 protruding beyond the first fixing block 11 along the first direction A1. The first contact portion 121 is formed on the first elastic arm 124. In the illustrated embodiment of the present disclosure, the first elastic arm 124 is cantilever-shaped and extends along the first direction A1. The first contact portion 121 corresponds to a corresponding first mating hole 331.

In the illustrated embodiment of the present disclosure, the plurality of first conductive terminals 12 at least include a first ground terminal G1, a first signal terminal S1, a second signal terminal S2, and a second ground terminal G2. The first signal terminal S1 and the second signal terminal S2 are located between the first ground terminal G1 and the second ground terminal G2. Preferably, the first signal terminal S1 and the second signal terminal S2 form a differential pair in order to increase the signal transmission rate.

The first metal shielding plate 13 includes a first base portion 131 located on one side of the first fixing block 11 along the second direction A2-A2 and a first extension portion 132 extending from the first base portion 131. The first extension portion 132 protrudes beyond the first fixing block 11 along the first direction A1. The first extension portion 132 includes a plurality of first grounding elastic arms 1321 protruding toward a side where the first contact portions 121 are located. In the illustrated embodiment of the present disclosure, the first grounding elastic arms 1321 are integrally stamped from the first extension portion 132. An extension direction of the first grounding elastic arm 1321 is opposite to an extension direction of the first elastic arm 124. The first grounding elastic arm 1321 of this design can reduce the risk of being damaged by the ground terminal of the mating connector 200.

In the illustrated embodiment of the present disclosure, the first body portion 131 includes a first rib 1311 and a second rib 1312. The first rib 1311 is configured to be in contact with the first fixing portion 122 of the first ground terminal G1. The second rib 1312 is configured to be in contact with the first fixing portion 122 of the second ground terminal G2.

Similarly, in the illustrated embodiment of the present disclosure, each second terminal module 2 includes a second fixing block 21, a plurality of second conductive terminals 22 fixed to the second fixing block 21, and a second metal shielding plate 23 located on at least one side of the second fixing block 21. In one embodiment of the present disclosure, the plurality of second conductive terminals 22 are insert-molded with the second fixing block 21.

Each second conductive terminal 22 includes a second contact portion 221 protruding beyond the second fixing block 21 along the first direction A1, a second fixing portion 222 fixed in the second fixing block 21, and a second mounting portion 223 protruding downwardly beyond the second fixing block 21 along the third direction A3-A3. The second mounting portion 223 is configured to be mounted to the circuit board 300 so as to achieve electrical connection with the circuit board 300. In the illustrated embodiment of the present disclosure, each second conductive terminal 22 includes a second elastic arm 224 protruding beyond the second fixing block 21 along the first direction A1. The second contact portion 221 is formed on the second elastic arm 224. In the illustrated embodiment of the present disclosure, the second elastic arm 224 is cantilever-shaped, and extends along the first direction A1. The second contact portion 221 corresponds to a corresponding second mating hole 332.

In the illustrated embodiment of the present disclosure, the plurality of second conductive terminals 22 at least include a third ground terminal G3, a third signal terminal S3, a fourth signal terminal S4 and a fourth ground terminal G4. The third signal terminal S3 and the fourth signal terminal S4 are located between the third ground terminal G3 and the fourth ground terminal G4. Preferably, the third signal terminal S3 and the fourth signal terminal S4 form a differential pair in order to increase the signal transmission rate.

The second metal shielding plate 23 includes a second body portion 231 located on one side of the second fixing block 21 along the second direction A2-A2 and a second extension portion 232 extending from the second base portion 231. The second extension portion 232 protrudes beyond the second fixing block 21 along the first direction A1. The second extension portion 232 includes a plurality of second grounding elastic arms 2321 protruding toward a side where the second contact portions 221 are located. In the illustrated embodiment of the present disclosure, the second grounding elastic arms 2321 are integrally stamped from the second extension portion 232. An extension direction of the second grounding elastic arm 2321 is opposite to an extension direction of the second elastic arm 224. The second grounding elastic arm 2321 of this design can reduce the risk of being damaged by the ground terminal of the mating connector 200.

In the illustrated embodiment of the present disclosure, the second body portion 231 includes a third rib 2311 and a fourth rib 2312. The third rib 2311 is configured to be in contact with the second fixing portion 222 of the third ground terminal G3. The fourth rib 2312 is configured to be in contact with the second fixing portion 222 of the fourth ground terminal G4.

In the illustrated embodiment of the present disclosure, the first ground terminal G1, the first signal terminal S1, the second signal terminal S2 and the second ground terminal G2 are staggered with respect to the third ground terminal G3, the third signal terminal S3, the fourth signal terminal S4 and the fourth ground terminal G4, respectively, along the third direction A3-A3.

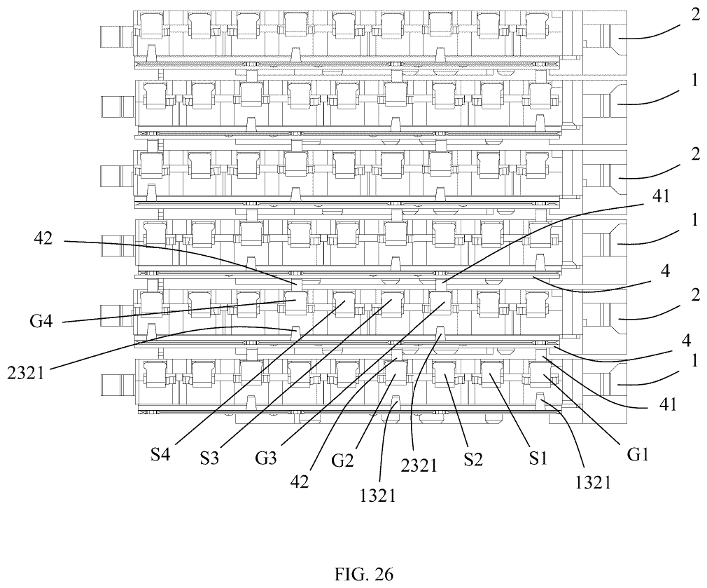

In the illustrated embodiment of the present disclosure, as shown in FIG. 26, in any adjacent first terminal module 1 and second terminal module 2, the plurality of first grounding elastic arms 1321 of the first metal shielding plate 13 of the first terminal module 1 and the plurality of second grounding elastic arms 2321 of the second metal shielding plate 23 of the second terminal module 2 are arranged in a staggered manner.

In the illustrated embodiment of the present disclosure, each grounding connection member 4 is at least partially located between one first terminal module 1 and one second terminal module 2. Some of the grounding connection members 4 are electrically connected to the ground terminals (for example, the first ground terminals G1 and/or the second ground terminals G2) of the first terminal modules 1 and the second metal shielding plates 23 of the second terminal modules 2, respectively. Another some of the grounding connection members 4 are electrically connected to the ground terminals of the second terminal modules 2 (for example, the third ground terminals G3 and/or the fourth ground terminals G4) and the first metal shielding plates 13 of the first terminal modules 1, respectively.

In the illustrated embodiment of the present disclosure, the grounding connection member 4 includes a main body portion 40, a first connecting arm 41 connected to the main body portion 40, and a second connecting arm 42 connected to the main body portion 40. The first connecting arm 41 and/or the second connecting arm 42 are integrally stamped from the main body portion 40; or, the first connecting arm 41 and/or the second connecting arm 42 are provided separately from the main body portion 40 and are fixed to the main body portion 40 by soldering or welding. In other embodiments of the present disclosure, the first connecting arm 41 and/or the second connecting arm 42 are integrally stamped from the second metal shielding plate 23; or, the first connecting arm 41 and/or the second connecting arm 42 are provided separately from the second metal shielding plate 23 and are fixed to the second metal shielding plate 23 by soldering or welding.

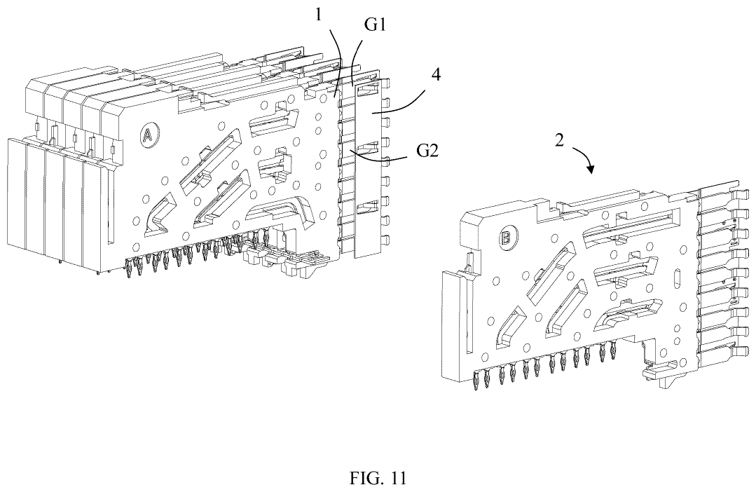

Referring to FIG. 11 to FIG. 19, taking the grounding connection member 4 located between the first terminal module 1 and the second terminal module 2 as an example, the main body portion 40 is in contact with the second metal shielding plate 23, the first connecting arm 41 is in contact with the first ground terminal G1, and the second connecting arm 42 is in contact with the second ground terminal G2. Specifically, the main body portion 40 is in contact with the second extension portion 232 of the second metal shielding plate 23, the first connecting arm 41 elastically abuts against the first elastic arm 124 of the first ground terminal G1, and the second connecting arm 42 elastically abuts against the second elastic arm 224 of the second ground terminal G2. In the illustrated embodiment of the disclosure, the first connecting arm 41, the second connecting arm 42, the first grounding elastic arm 1321 and the second grounding elastic arm 2321 extend in the same direction.

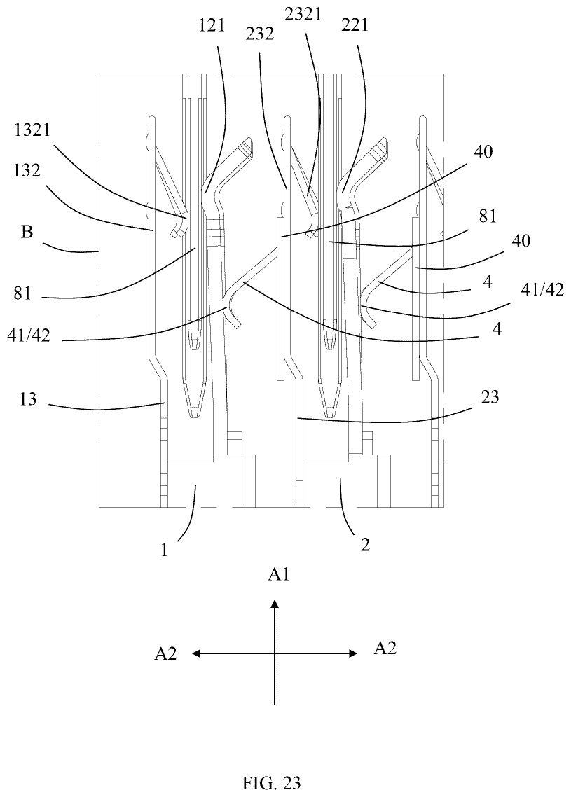

Referring to FIG. 23, along the first direction A1, the first connecting arm 41 and the second connecting arm 42 are located at a rear end of the first grounding elastic arm 1321 and the second grounding elastic arm 2321.

The positioning block 5 is configured to be mounted to a bottom of the first fixing blocks 11 and the second fixing blocks 21. In the illustrated embodiment of the present disclosure, the positioning block 5 defines a plurality of slots 51. The first mounting portions 123 and the second mounting portions 223 pass downwardly through corresponding slots 51.

The insertion sheet 61 is configured to combine the plurality of the first terminal modules 1 and the plurality of the second terminal modules 2 into a whole in order to prevent loosening. In the illustrated embodiment of the present disclosure, the insertion sheet 61 is made of metal material.

The retaining sheet 62 is configured to combine the plurality of the first terminal modules 1 and the plurality of the second terminal modules 2 into a whole. On the one hand, it prevents loosening; on the other hand, the retaining sheet 62 combines the first metal shielding plates 13 and the first fixing blocks 11 into a whole, and combines the second metal shielding plates 23 and the second fixing blocks 21 into a whole. Besides, the retaining sheet 62 is in contact with the first metal shielding plates 13 of the first terminal modules 1 and the second metal shielding plates 23 of the second terminal modules 2, so as to connect them in series. In the illustrated embodiment of the present disclosure, the retaining sheet 62 is made of metal material.

When the mating connector 200 is mated with the modular connector 100, the insertion portions 81 of the mating conductive terminals 8 of the mating connector 200 are in contact with corresponding first contact portions 121 of the first conductive terminals 12, corresponding first grounding elastic arms 1321, corresponding second contact portions 221 of the second conductive terminals 22 and corresponding second grounding elastic arms 2321.

Specifically, the insertion portions 81 of some of the ground terminals of the mating connector 200 are clamped by the first contact portions 121 of the first ground terminals G1 and some of the first grounding elastic arms 1321 of the first metal shielding plates 13. The insertion portions 81 of some of the ground terminals of the mating connector 200 are clamped by the first contact portions 121 of the second ground terminals G2 and some of the first grounding elastic arms 1321 of the first metal shielding plates 13. The insertion portions 81 of some of the ground terminals of the mating connector 200 are clamped by the second contact portions 221 of the third ground terminals G3 and some of the second grounding elastic arms 2321 of the second metal shielding plates 23. The insertion portions 81 of some of the ground terminals of the mating connector 200 are clamped by the second contact portions 221 of the fourth ground terminals G4 and some of the second grounding elastic arms 2321 of the second metal shielding plates 23. The insertion portions 81 of some of the signal terminals of the mating connector 200 are in side contact with corresponding first contact portions 121 of the first signal terminals S1 and corresponding first contact portions 121 of the second signal terminal S2, respectively. The insertion portions 81 of some of the signal terminals of the mating connector 200 are in side contact with corresponding second contact portions 221 of the third signal terminal S3 and corresponding second contact portions 221 of the fourth signal terminals S4, respectively.

It is understandable to those skilled in the art that when the insertion portions 81 of the ground terminals of the mating connector 200 are inserted in place, the first connecting arm 41 and the second connecting arm 42 will elastically deform, thereby providing a certain contact force to the insertion portions 81 of corresponding ground terminals, and improving the insertion and extraction force.

It is understandable to those skilled in the art that when the mating connector 200 is mated with the modular connector 100, the first metal shielding plates 13 of the first terminal module 1, the first ground terminals G1, the second ground terminals G2, corresponding grounding connection members 4, the second metal shielding plates 23 of the second terminal modules 2, the third ground terminals G3, the fourth ground terminals G4, and the ground terminals of the mating connector 200 are all connected in series, thereby increasing the common grounding area and improving the quality of signal transmission.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A modular connector, comprising:
a first housing comprising a first base; the first base comprising a first mating surface, a plurality of first mating holes extending through the first mating surface, and a plurality of second mating holes extending through the first mating surface;
a first terminal module being at least partially assembled to the first housing; the first terminal module comprising a first fixing block, a plurality of first conductive terminals fixed to the first fixing block, and a first metal shielding plate located on at least one side of the first fixing block; each first conductive terminal comprising a first contact portion protruding beyond the first fixing block along a first direction; the first contact portion being disposed corresponding to a corresponding first mating hole; the plurality of first conductive terminals comprising at least a first ground terminal, a first signal terminal, a second signal terminal and a second ground terminal; the first signal terminal and the second signal terminal being located between the first ground terminal and the second ground terminal; the first metal shielding plate comprising a first extension portion protruding beyond the first fixing block along the first direction; the first extension portion comprising a first grounding elastic arm protruding toward a side where the first contact portions are located;
a second terminal module being at least partially assembled to the first housing; the second terminal module comprising a second fixing block, a plurality of second conductive terminals fixed to the second fixing block, and a second metal shielding plate located on at least one side of the second fixing block; each second conductive terminal comprising a second contact portion protruding beyond the second fixing block along the first direction; the second contact portion being disposed corresponding to a corresponding second mating hole; the plurality of second conductive terminals comprising at least a third ground terminal, a third signal terminal, a fourth signal terminal and a fourth ground terminal; the third signal terminal and the fourth signal terminal being located between the third ground terminal and the fourth ground terminal; the second metal shielding plate comprising a second extension portion protruding beyond the second fixing block along the first direction; the second extension portion comprising a second grounding elastic arm protruding toward a side where the second contact portions are located; and
a grounding connection member being at least partially located between the first terminal module and the second terminal module; the grounding connection member being electrically connected to the first ground terminal, the second ground terminal and the second metal shielding plate, respectively.

2. The modular connector according to claim 1, wherein the grounding connection member comprises a first connecting arm and a second connecting arm; the grounding connection member is electrically connected to the second metal shielding plate; the first connecting arm is in contact with the first ground terminal; the second connecting arm is in contact with the second ground terminal.

3. The modular connector according to claim 2, wherein the grounding connection member comprises a main body portion; the first connecting arm and the second connecting arm are both connected to the main body portion; the main body portion is in contact with the second metal shielding plate; the first connecting arm and/or the second connecting arm are integrally stamped from the main body portion; or
the grounding connection member comprises a main body portion; the first connecting arm and the second connecting arm are both connected to the main body portion; the main body portion is in contact with the second metal shielding plate; the first connecting arm and/or the second connecting arm are provided separately from the main body portion, and are fixed to the main body portion by soldering or welding; or
the first connecting arm and/or the second connecting arm are integrally stamped from the second metal shielding plate; or
the first connecting arm and/or the second connecting arm are provided separately from the second metal shielding plate, and are fixed to the second metal shielding plate by soldering or welding.

4. The modular connector according to claim 2, wherein the grounding connection member comprises a main body portion; the first connecting arm and the second connecting arm are both connected to the main body portion; the main body portion is in contact with the second extension portion of the second metal shielding plate;
each first conductive terminal comprises a first elastic arm protruding beyond the first fixing block; the first contact portion is formed on the first elastic arm; the first connecting arm is in elastic contact with the first elastic arm of the first ground terminal;
each second conductive terminal comprises a second elastic arm protruding beyond the second fixing block; the second contact portion is formed on the second elastic arm; the second connecting arm is in elastic contact with the second elastic arm of the second ground terminal.

5. The modular connector according to claim 4, wherein the first grounding elastic arm is integrally stamped from the first extension portion; an extension direction of the first grounding elastic arm is opposite to an extension direction of the first elastic arm.

6. The modular connector according to claim 4, wherein an extension direction of the first connecting arm, an extension direction of the second connecting arm and an extension direction of the first grounding elastic arm are the same.

7. The module connector according to claim 1, wherein the first metal shielding plate comprises a first base portion located on one side of the first fixing block; the first base portion comprises a first rib and a second rib; the first rib is in contact with the first ground terminal; the second rib is in contact with the second ground terminal;
the second metal shielding plate comprises a second base portion located on one side of the second fixing block; the second base portion comprises a third rib and a fourth rib; the third rib is in contact with the third ground terminal; the fourth rib is in contact with the fourth ground terminal.

8. The modular connector according to claim 1, wherein along the first direction, both the first connecting arm and the second connecting arm are located at a rear end of the first grounding elastic arm.

9. A modular connector, comprising:
a first housing;
a plurality of first terminal modules being at least partially assembled to the first housing; each first terminal module comprising a first fixing block, a plurality of first conductive terminals fixed to the first fixing block, and a first metal shielding plate located on at least one side of the first fixing block; each first conductive terminal comprising a first contact portion protruding beyond the first fixing block along a first direction; the plurality of first conductive terminals at least comprising ground terminals and signal terminals; the first metal shielding plate comprising a first extension portion protruding beyond the first fixing block along the first direction; the first extension portion comprising a first grounding elastic arm protruding toward a side where the first contact portions are located;
a plurality of second terminal modules being at least partially assembled to the first housing; each second terminal module comprising a second fixing block, a plurality of second conductive terminals fixed to the second fixing block, and a second metal shielding plate located on at least one side of the second fixing block; each second conductive terminal comprising a second contact portion protruding beyond the second fixing block along the first direction; the plurality of second conductive terminals at least comprising ground terminals and signal terminals; the second metal shielding plate comprising a second extension portion protruding beyond the second fixing block along the first direction; the second extension portion comprising a second grounding elastic arm protruding toward a side where the second contact portions are located;
a plurality of grounding connection members; the plurality of first terminal modules and the plurality of second terminal modules being alternately arranged along a second direction; each grounding connection member being at least partially located between one first terminal module and one second terminal module; some of the grounding connection members are electrically connected to the ground terminals of the first terminal modules and the second metal shielding plates of the second terminal modules, respectively; another some of the grounding connection members are electrically connected to the ground terminals of the second terminal modules and the first metal shielding plates of the first terminal modules, respectively.

10. The modular connector according to claim 9, wherein the ground terminals of the first terminal module comprise a first ground terminal and a second ground terminal; the signal terminals of the first terminal module comprise a first signal terminal and a second signal terminal; the first signal terminal and the second signal terminal are located between the first ground terminal and the second ground terminal;
the ground terminals of the second terminal module comprise a third ground terminal and a fourth ground terminal; the signal terminals of the second terminal module comprise a third signal terminal and a fourth signal terminal; the third signal terminal and the fourth signal terminal are located between the third ground terminal and the fourth ground terminal.

11. The modular connector according to claim 10, wherein the first ground terminal, the first signal terminal, the second signal terminal and the second ground terminal are staggered with respect to the third ground terminal, the third signal terminal, the fourth signal terminal and the fourth ground terminal, respectively, along a third direction; any two of the first direction, the second direction and the third direction are perpendicular to each other.

12. The modular connector according to claim 11, wherein each grounding connection member comprises a first connecting arm and a second connecting arm; the some of the grounding connection members are electrically connected to the second metal shielding plates, wherein the first connecting arms are in contact with the first ground terminals and the second connecting arms are in contact with the second ground terminals; the another some of the grounding connection members are electrically connected to the first metal shielding plates, wherein the first connecting arms are in contact with the third ground terminals, and the second connecting arms are in contact with the fourth ground terminals.

13. The modular connector according to claim 11, wherein each grounding connection member comprises a main body portion; the first connecting arm and the second connecting arm are both connected to the main body portion; the main body portions of the some of the grounding connection members are in contact with the second metal shielding plates; the main body portions of the another some of the grounding connection members are in contact with the first metal shielding plates; the first connecting arm and/or the second connecting arm are integrally stamped from the main body portion; or
each grounding connection member comprises a main body portion; the first connecting arm and the second connecting arm are both connected to the main body portion; the main body portions of the some of the grounding connection members are in contact with the second metal shielding plates; the main body portions of the another some of the grounding connection members are in contact with the first metal shielding plates; the first connecting arm and/or the second connecting arm are provided separately from the main body portion and are fixed to the main body portion by soldering or welding; or
the first connecting arm and/or the second connecting arm of the some of the grounding connection members are integrally stamped from a corresponding second metal shielding plate; the first connecting arm and/or the second connecting arm of the another some of the grounding connection members are integrally stamped from a corresponding first metal shielding plate; or
the first connecting arm and/or the second connecting arm of the some of the grounding connection members are arranged separately from a corresponding second metal shielding plate, and are fixed to the corresponding second metal shielding plate by soldering or welding; the first connecting arm and/or the second connecting arm of the another some of the grounding connection members are arranged separately from a corresponding first metal shielding plate, and are fixed to the corresponding first metal shielding plate by soldering or welding.

14. A connector assembly, comprising:
a module connector; and
a mating connector comprising a second housing and a plurality of mating conductive terminals fixed to the second housing; the second housing defining a receiving space configured to at least partially receive the modular connector; each mating conductive terminal comprising an insertion portion protruding into the receiving space;
the modular connector comprising:
a first housing comprising a first base; the first base comprising a first mating surface, a plurality of first mating holes extending through the first mating surface, and a plurality of second mating holes extending through the first mating surface;
a first terminal module being at least partially assembled to the first housing; the first terminal module comprising a first fixing block, a plurality of first conductive terminals fixed to the first fixing block, and a first metal shielding plate located on at least one side of the first fixing block; each first conductive terminal comprising a first contact portion protruding beyond the first fixing block along a first direction; the first contact portion being disposed corresponding to a corresponding first mating hole; the plurality of first conductive terminals comprising at least a first ground terminal, a first signal terminal, a second signal terminal and a second ground terminal; the first signal terminal and the second signal terminal being located between the first ground terminal and the second ground terminal; the first metal shielding plate comprising a first extension portion protruding beyond the first fixing block along the first direction; the first extension portion comprising a first grounding elastic arm protruding toward a side where the first contact portions are located;
a second terminal module being at least partially assembled to the first housing; the second terminal module comprising a second fixing block, a plurality of second conductive terminals fixed to the second fixing block, and a second metal shielding plate located on at least one side of the second fixing block; each second conductive terminal comprising a second contact portion protruding beyond the second fixing block along the first direction; the second contact portion being disposed corresponding to a corresponding second mating hole; the plurality of second conductive terminals comprising at least a third ground terminal, a third signal terminal, a fourth signal terminal and a fourth ground terminal; the third signal terminal and the fourth signal terminal being located between the third ground terminal and the fourth ground terminal; the second metal shielding plate comprising a second extension portion protruding beyond the second fixing block along the first direction; the second extension portion comprising a second grounding elastic arm protruding toward a side where the second contact portions are located; and
a grounding connection member being at least partially located between the first terminal module and the second terminal module; the grounding connection member being electrically connected to the first ground terminal, the second ground terminal and the second metal shielding plate, respectively;
wherein the insertion portions are configured to be in contact with a corresponding first contact portion of the first conductive terminal, a corresponding first grounding elastic arm, a corresponding second contact portion of the second conductive terminal and a corresponding second grounding elastic arm.

15. The connector assembly according to claim 14, wherein the grounding connection member comprises a first connecting arm and a second connecting arm; the grounding connection member is electrically connected to the second metal shielding plate; the first connecting arm is in contact with the first ground terminal; the second connecting arm is in contact with the second ground terminal.

16. The connector assembly according to claim 15, wherein the grounding connection member comprises a main body portion; the first connecting arm and the second connecting arm are both connected to the main body portion; the main body portion is in contact with the second metal shielding plate; the first connecting arm and/or the second connecting arm are integrally stamped from the main body portion; or
the grounding connection member comprises a main body portion; the first connecting arm and the second connecting arm are both connected to the main body portion; the main body portion is in contact with the second metal shielding plate; the first connecting arm and/or the second connecting arm are provided separately from the main body portion, and are fixed to the main body portion by soldering or welding; or
the first connecting arm and/or the second connecting arm are integrally stamped from the second metal shielding plate; or
the first connecting arm and/or the second connecting arm are provided separately from the second metal shielding plate, and are fixed to the second metal shielding plate by soldering or welding.

17. The connector assembly according to claim 15, wherein the grounding connection member comprises a main body portion; the first connecting arm and the second connecting arm are both connected to the main body portion; the main body portion is in contact with the second extension portion of the second metal shielding plate;
each first conductive terminal comprises a first elastic arm protruding beyond the first fixing block; the first contact portion is formed on the first elastic arm; the first connecting arm is in elastic contact with the first elastic arm of the first ground terminal;
each second conductive terminal comprises a second elastic arm protruding beyond the second fixing block; the second contact portion is formed on the second elastic arm; the second connecting arm is in elastic contact with the second elastic arm of the second ground terminal.

18. The connector assembly according to claim 17, wherein the first grounding elastic arm is integrally stamped from the first extension portion; an extension direction of the first grounding elastic arm is opposite to an extension direction of the first elastic arm.

19. The connector assembly according to claim 17, wherein an extension direction of the first connecting arm, an extension direction of the second connecting arm and an extension direction of the first grounding elastic arm are the same.

20. The connector assembly according to claim 14, wherein the first metal shielding plate comprises a first base portion located on one side of the first fixing block; the first base portion comprises a first rib and a second rib; the first rib is in contact with the first ground terminal; the second rib is in contact with the second ground terminal;
the second metal shielding plate comprises a second base portion located on one side of the second fixing block; the second base portion comprises a third rib and a fourth rib; the third rib is in contact with the third ground terminal; the fourth rib is in contact with the fourth ground terminal.
